(19) United States
(12) Patent Application Publication
(10) Pub. No.: US 2025/0276459 A1
(43) Pub. Date: Sep. 4, 2025

(54) TRIMMER WITH MULTIPLE SETTINGS

(71) Applicant: Chuka Torres, West Hollywood, CA (US)

(72) Inventor: Chuka Torres, West Hollywood, CA (US)

(21) Appl. No.: 19/065,327

(22) Filed: Feb. 27, 2025

Related U.S. Application Data
(60) Provisional application No. 63/559,508, filed on Feb. 29, 2024.

(51) Int. Cl. B26B 19/20; B26B 19/06; B26B 19/38

(52) U.S. Cl. CPC B26B 19/205; B26B 19/06; B26B 19/386

(57) ABSTRACT

A head of the trimmer includes a fixed blade and vibrating blade joined together through a block in a manner allowing vibration of the vibrating blade relative to the fixed blade. A block is attached to the vibrating blade in a removable fashion, and resides within a slot which allows the vibrating blade and block to slide relative to the fixed blade and remain connected to the fixed blade. The block can be removed, flipped and reattached, with the block being provided with top and bottom offsets which are different in size from each other, such that flipping of the block causes a tip line of teeth of the vibrating blade to have a different offset with a tip line of teeth of the fixed blade. The trimmer can thus be reconfigured between a standard configuration and a tight configuration, the tight configuration cutting hair shorter than the standard configuration.

### CROSS-REFERENCE TO RELATED APPLICATIONS

This application claims benefit under Title 35, United States Code § 119(e) of U.S. Provisional Application No. 63/559,508 filed on Feb. 29, 2024.

### FIELD OF THE INVENTION

The following invention relates to electrically powered trimmers and clippers for cutting hair. More particularly, this invention relates to haircutting trimmers and clippers which can be adjusted between at least two settings, which settings cut the hair to different lengths.

### BACKGROUND OF THE INVENTION

Hair trimmers are known in the prior art for cutting hair. Typical hair trimmers are electric powered and can be either corded or cordless. Hair trimmers include a head assembly with a fixed blade and a vibrating blade. The first fixed blade has a series of teeth at a tip thereof. The second vibrating blade is adjacent to the fixed blade and also has a series of teeth at a tip thereof. The vibrating blade moves laterally relative to the fixed blade, causing the teeth of the fixed blade and the vibrating blade to move into and out of alignment with each other. Lateral sides of these teeth are sharpened so that they act somewhat like scissors and cut hair passing between these teeth.

Typically, the teeth of the vibrating blade are aligned along a straight line at their tip which extends slightly less away from a main body of the vibrating blade than a line along which tips of the teeth on the fixed blade are located. This small offset allows the teeth of the fixed blade to act somewhat like a “standoff” to keep the teeth from cutting skin from which the hair to be cut is growing.

It is known in the prior art to “set” the position of the vibrating blade relative to the fixed blade to control this amount of offset. A typical regular setting for a trimmer is to have just enough offset so that the risk of cutting skin is essentially zero. In this regular setting, a barber (or the individual cutting hair) does not need to exercise extra care to avoid cutting skin. However, as a trade-off, hair cannot be cut quite as short in such a regular setting.

Skilled barbers will often set their vibrating blade position to a somewhat tighter position than the regular setting. With such a tighter setting, the hair can be cut shorter and with skill and experience a trimmer with such a tight blade setting can still be safely used.

With prior art trimmers the process of setting the height of the vibrating blade typically involves loosening screws or other fasteners which hold the vibrating blade. Then the vibrating blade is positioned where desired, and finally the screws or other fasteners are tightened to cause the trimmer to hold this new setting. To get the setting right, tools can be utilized. One such tool is known as a blade setter and is similar to that shown and described in U.S. Pat. No. D785,249, incorporated herein by reference and by including a copy within the Appendix of this application.

Even with tools to assist in setting the blade where desired, significant time (and care) is involved in performing this setting procedure. Furthermore, if the setting procedure is not done properly the trimmer can be left in a state which is suboptimal. While a barber could maintain two trimmers, one at a regular (or standard) setting and one at a tight setting, this is wasteful of trimmer resources. Accordingly, a need exists for a trimmer which can be rapidly and reliably transitioned between a regular setting and a tight setting.

### SUMMARY OF THE INVENTION

With this invention, a hair trimmer is provided which has at least two settings, such as a regular (or standard) setting and a tight setting. In one embodiment disclosed in the included figures, a base of the fixed blade is provided with a dovetail slot which extends laterally generally parallel with a line at which tips of the teeth of the fixed blade are oriented. This dovetail slot in this embodiment extends entirely from a first lateral edge to a second lateral edge of the fixed blade, but could stop short of these lateral edges as an option. In other embodiments, this slot could have a different contour.

A proximal end of the base of the fixed blade (and of the overall head assembly) preferably includes a pair of retainer seats therein. These retainer seats are sized and positioned to allow spring ball retainers to reside therein and to removably hold the head assembly attached to a neck of a trimmer handle. The handle is configured within a hand grip sized case in one embodiment, similar to the handle shown in U.S. Patent Application Publication No. 2023/0278243, incorporated herein by reference in its entirety. The handle can be easily gripped and wielded by a barber or other user. This handle can house a battery or can support an electric cord attachable to a source of electric power. A vibrating motor within the handle has an output which interacts with horns (or a collar) of the head assembly and which causes the vibratory blade of the head assembly to vibrate relative to the fixed blade when the head assembly is attached to the neck of the handle and the vibratory output tip of the output of the vibrating motor engages these horns. The neck also supports a pair of spring ball retainers which are spring loaded towards an elevated position, but can be depressed when compressive forces are applied to these balls. The balls can seat within the spring ball retainer seats in the proximal end of the base of the fixed blade, which proximal end also provides a proximal end for the entire head assembly.

The vibrating blade is provided as part of the head assembly and is configured to vibrate back and-forth under action from the tip of the output of the vibrating motor. The fixed blade and the proximal end of the head assembly are held stationary by the ball retainers and the neck of the handle. The proximal end of the head assembly includes flanges which engage within slots in the neck of the handle to allow for the head assembly to slide into and be firmly held by the neck of the handle, and resist sliding and falling out of the neck by the spring force of the spring ball retainers nesting at least somewhat into the retainer seats in the proximal end of the head assembly.

A block is provided between the vibrating blade and the fixed blade. This block, in one embodiment, resides within a corresponding slot of the fixed blade. The block has at least one raised region sized to fit within a recess in the vibrating blade. Block fasteners allow for the block to be fastened to the vibrating blade, such as through a base block on a side of the vibrating blade opposite of the fixed blade. The block fasteners (typically two screws, but could optionally be rivets or other permanent fasteners) securely but removably hold the vibrating blade to the block. In alternative embodiments, the block could have a contour other than a dovetail contour.

The block has a size at the raised region (in a direction perpendicular to a tip line at which tips of the teeth terminate) which is less than a size of the recess in the vibrating blade, by at least a defined adjustment amount. This causes a small gap to exist adjacent to at least one side of the raised region. In one embodiment, this adjustment amount is about 0.1 mm. Thus for instance, the size of the raised region of the block would be at least about 0.1 mm less than the size of the recess. In other embodiments, this tolerance and adjustment amount could be in a range from 0.1 mm to 0.5 mm, either built into the trimmer or selected by a user, such as by using a desired block from a set of different size blocks.

The block can be removed from the vibrating blade, after the vibrating blade and the block are slid off of the fixed blade. Such removal first involves removing fasteners which hold the block to the vibrating blade. The block can then be flipped and rotated with its at least one raised region fitting again within the recess. By making the raised regions asymmetrical and/or by putting a through bore in the block (that has the screw or other fastener passing therethrough) and a threaded bore of the vibrating blade asymmetrically located relative to the dovetail of the block, the block causes the vibrating blade to be in a standard or a tight position, depending on if the block is in a standard orientation or a tight orientation.

### OBJECTS OF THE INVENTION

Accordingly, a primary object of the present invention is to provide a trimmer which has both a standard configuration and a tight configuration with the tight configuration cutting hair shorter than the standard configuration.

Another object of the present invention is to provide a trimmer which can be reconfigured either to accommodate sensitive skin or a less experienced user in a first configuration and provide a shorter cut and tighter hairline shaping by a skilled user when in a second configuration.

Another object of the present invention is to provide a trimmer with a standard and a tight configuration which is quick and easy to reconfigure when desired.

Another object of the present invention is to provide a trimmer with a tight configuration and a standard configuration which operates similarly in each configuration, but merely with a slightly different offset between tip lines of fixed and vibrating teeth in the two configurations.

Another object of the present invention is to balance safety and comfort with exceptionally high quality hairline shaping in a single trimmer tool.

Another object of the present invention is provide a hair trimmer tool which maintains its offset between fixed teeth and vibrating teeth, even after long periods of use thereof, with a minimum of wear or other performance degradation.

Another object of the present invention is to provide a method for reconfiguring a hair trimmer between a standard configuration and a tight configuration so that a single tool can provide two different configurations to a user and a simple and fast method for reconfiguring the hair trimmer tool between configurations.

Other further objects of the present invention will become apparent from a careful reading of the included drawing figures, the claims and detailed description of the invention.

### BRIEF DESCRIPTION OF THE DRAWINGS

FIG. 1 is an exploded parts perspective view of a trimmer tool according to one embodiment of this invention, and showing a handle of the tool exploded into separate parts and a head of the tool exploded into separate parts.

FIG. 2 is a perspective view similar to that which is shown in FIG. 1, but with the handle assembled together and the head assembled together, but with the head exploded off of the handle as it would be when removed from a neck of the handle.

FIG. 3 is a perspective view of the tool when the head is attached to the neck of the handle and ready for use.

FIG. 4 is a bottom plan view of that which is shown in FIG. 3.

FIG. 5 is a left side elevation view of that which is shown in FIG. 3, the right side elevation view being a mirror image of that which is shown in FIG. 5.

FIG. 6 is a top plan view of that which is shown in FIG. 3.

FIG. 7 is an upper end elevation view of that which is shown in FIG. 3.

FIG. 8 is a base end elevation view of that which is shown in FIG. 3.

FIG. 9 is a perspective view from below of the head portion of that which is shown in FIGS. 1-3.

FIG. 10 is a top plan view of that which is shown in FIG. 9.

FIG. 11 is a left side elevation view of that which is shown in FIG. 9.

FIG. 12 is a bottom plan view of that which is shown in FIG. 9.

FIG. 13 is a right side elevation view of that which is shown in FIG. 9.

FIG. 14 is a perspective view of the head of FIG. 9 with the vibrating blade slid off of the fixed blade and with a dovetail block and screws exploded away from the vibrating block as they would be when removing the screws and dovetail block for a first step in reconfiguring of the head between a standard configuration and a tight configuration.

FIG. 15 is a perspective view similar to that which is shown in FIG. 14, but with the dovetail block beginning a flipping procedure to reorient the vibrating blade relative to the fixed blade for reconfiguring the head between the standard configuration and the tight configuration.

FIG. 16 is a perspective view similar to that which is shown in FIG. 15, but when the dovetail block has nearly completed its flipping procedure.

FIG. 17 is a perspective view similar to that which is shown in FIG. 16, but with the dovetail block having been fully flipped and mostly repositioned relative to the vibrating block and ready for receiving the screws to reattach the dovetail block to the vibrating block before sliding the vibrating blade and dovetail block back into the dovetail slot of the fixed blade, for completion of the process of reconfiguring the head between the tight configuration and the standard configuration. FIG. 17 also shows an alternative embodiment for the vibrating blade with a set screw as one form of tension adjustment between the vibrating blade and the fixed blade.

FIG. 18 is a perspective view of a detail of the head after full reassembly and with the teeth of the head in a tight configuration.

FIG. 19 is a perspective view of that which is shown in FIG. 18, but with the teeth of the head in a standard configuration before the reconfiguration process illustrated in FIGS. 14-17.

### DESCRIPTION OF THE PREFERRED EMBODIMENT

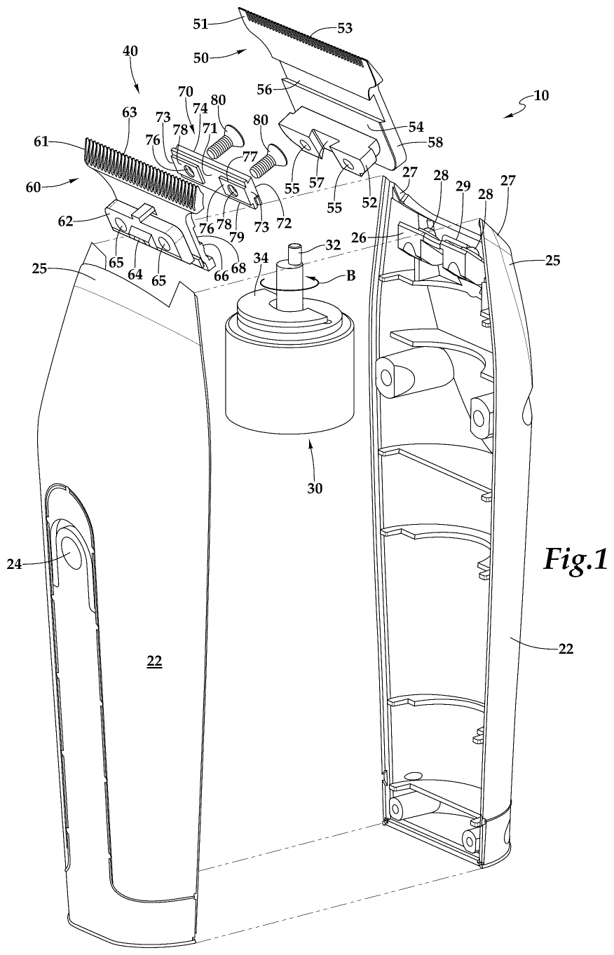

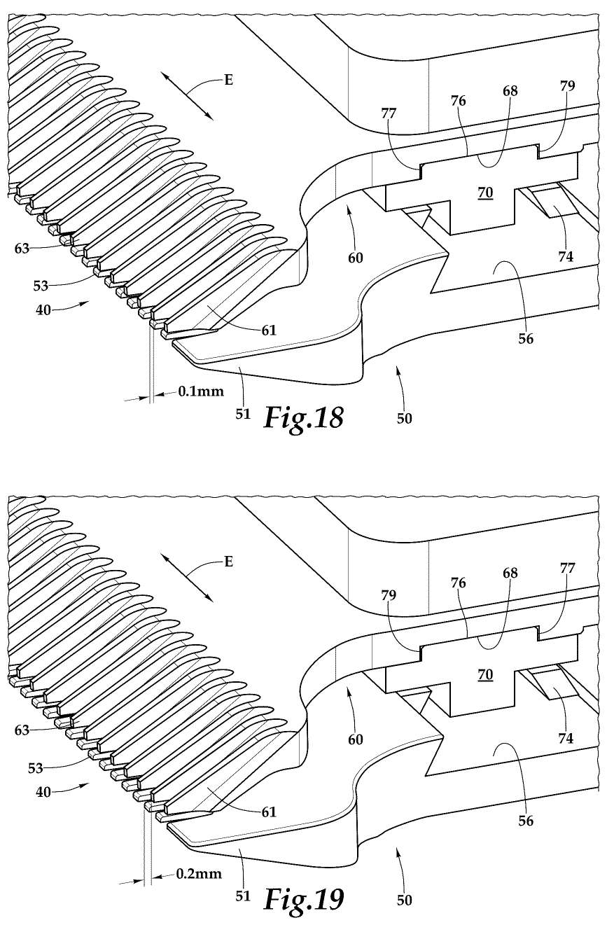

Referring to the drawings, wherein like reference numerals represent like parts throughout the various drawing figures, reference numeral 10 is directed to a trimmer for cutting hair (FIGS. 1-3). The trimmer 10 can be reconfigured between a tight configuration (FIG. 18) and a standard configuration (FIG. 19), with the tight configuration cutting hair shorter than the standard configuration. A user can thus configure the trimmer 10 in a desired way for either a standard cut or a tight cut.

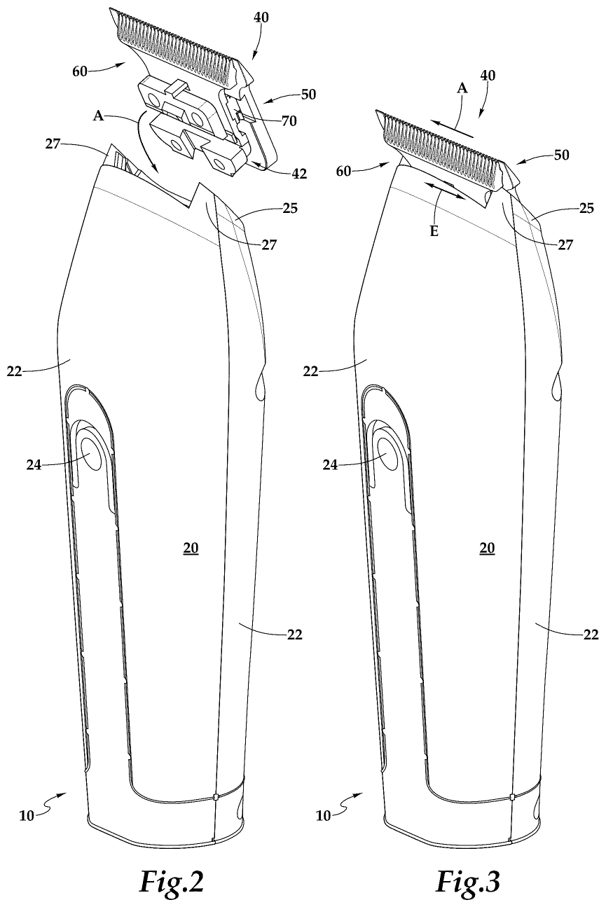

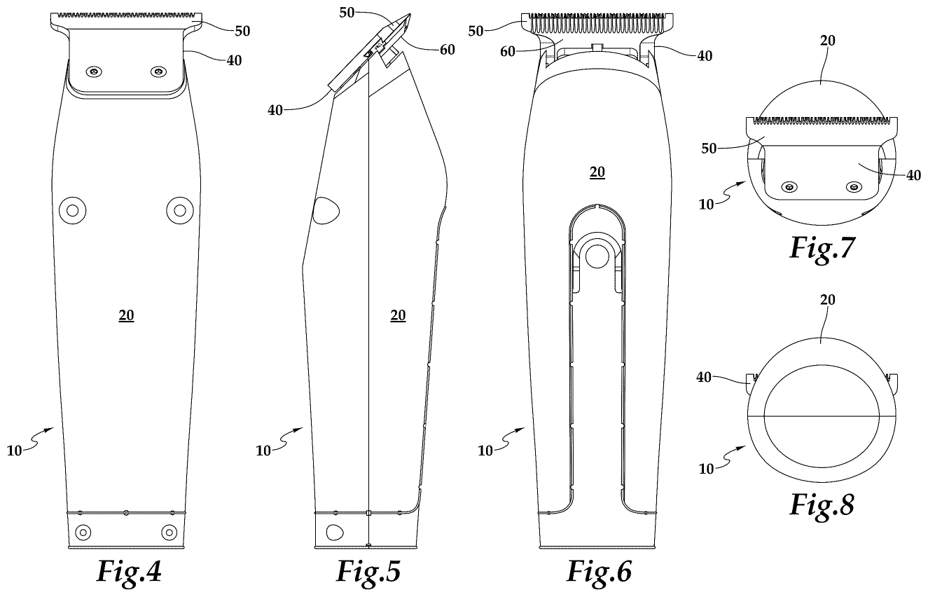

In essence, and with particular reference to FIG. 1, basic details of trimmers of this invention are described, according to one example embodiment. The trimmer 10 includes a handle 20 (FIGS. 2 and 3) having a hand grip size and shape. A motor 30 is contained within the handle 20 and drives vibratory operation of a head 40, which is removably attachable to the handle 20 (along arrow A of FIG. 2).

The head includes a fixed blade 50 and vibrating blade 60 which are held together in a fixed relationship other than facilitating vibration of the vibrating blade 60 back-and-forth relative to the fixed blade 50 along a vibrating movement (arrow E of FIGS. 3, 18 and 19) parallel with tips 51, 61 of the blades 50, 60. A block 70 joins the vibrating blade 60 to the fixed blade 50. The block 70 can be removably attached, such as through screws 80, to the vibrating blade 60 in two different orientations which correspond with the standard configuration (FIG. 19) and the tight configuration (FIG. 18) of the trimmer 10.

More specifically, and with continuing reference to FIGS. 1-3, details of the handle 20 and motor 30 of the trimmer 10 are described, according to one example embodiment. In this embodiment, the handle 20 is formed of two separate housing halves 22 which fit together in a clamshell manner to enclose all of the handle 20 other than an opening at a neck 25 at an upper end of the handle 20. Handle 20 supports charging contacts should the trimmer 10 be of a rechargeable cordless style, or can support a strain relief and cord if of a corded style.

A motor 30 is supported within the handle 20 for powering the trimmer 10. This motor 30 is typically coupled to a battery which is also contained within the handle 20. A switch 24 is provided on the handle 20, which allows for opening and closing of a circuit with battery contacts, for turning the motor 30 on and off. The neck 25 includes flanges 27 on lateral sides thereof slightly above a shelf 26 which is parallel with but recessed below the flanges 27 slightly. The flanges 27 extend inwardly toward each other somewhat on opposing sides of the neck 25. The shelf 26 supports a pair of spring ball retainers 28 which extend up toward a plane in which the neck 25 is located just enough that the spring balls interfere with the head 40 of the trimmer 20 when it is slid onto and off of the flanges 27 of the neck 25 (along arrow A of FIG. 2).

The head 40 includes a pair of recesses 55 in the fixed blade 50 of the head 40 which are spaced apart a similar distance that the spring ball retainers 28 are spaced from each other. The recesses 55 are strategically located so that when the head 40 is slid onto the flanges 27 on lateral sides of the neck 25 of the handle 20, along arrow A of FIG. 2, the recesses 55 come into alignment with the spring ball retainers 28. The spring ball retainers 28 are biased toward a position with the balls elevated to block passage of the head 40 between the flanges 27 and onto the neck 25. However, these balls of the spring ball retainers 28 can be collapsed slightly to allow the head 40 to pass fully onto the neck 25 of the handle 20, and then the balls are able to snap into the recesses 55 and hold the head 40 onto the handle 20.

A firm force opposite arrow A applied to the head 40 relative to the handle 20 allows for the balls to be compressed into the spring ball retainers 28 and out of the recesses 55, sufficient to allow the head 40 to be slid off of the handle 20 when desired (such as when it is desired to reconfigure the head 40 to transition the trimmer 10 from a standard configuration (FIG. 19) into a tight configuration (FIG. 18). A trapezoidal post 29 is also preferably provided extending up from the shelf 26 which can align with portions of the head 40 to further aid in securing the head 40 in a removable fashion onto the handle 20, and so that the head 40 remains firmly fixed to the handle 20 during use of the trimmer 10.

The motor 30 is an electric motor which receives electric power from a battery or from some other electric power source, such as that supplied through a cord interfacing with the motor 30 through the handle 20, and also with the switch 24 on the handle 20. The motor 30 has an output shaft on an upper end thereof which is fitted with an eccentric output tip 32. This eccentric output tip 32 has a rotational axis aligned with an output shaft of the motor 30, but a portion of the eccentric output tip 32 most elevated above the motor 30 is offset from this rotational axis slightly (e.g. 5 mm). Thus, this elevated portion follows a tight circular path as it rotates (along arrow B of FIG. 1) when the motor 30 is operational.

This elevated portion of the eccentric output tip 32 resides within a collar 64 associated with the vibrating blade 60, which collar is caused to slide back-and-forth (along arrow E of FIGS. 3, 18 and 19) when the head 40 is attached to the handle 20 and the motor 30 is operating. A counter balance 34 is also preferably attached to an output shaft of the motor 30 which counter balance 34 has a center of mass opposite a center of mass of the eccentric output tip 32 of the motor 30. In this way, the output shaft of the motor 30 is balanced, but still has an elevated portion which revolves about the rotational axis of the motor, to cause vibrational motion (along arrow E) of the vibrating blade 60. Typically, various electronics or other electric circuitry are also coupled to the motor 30 as well as to a battery and/or electric cord and the switch 24.

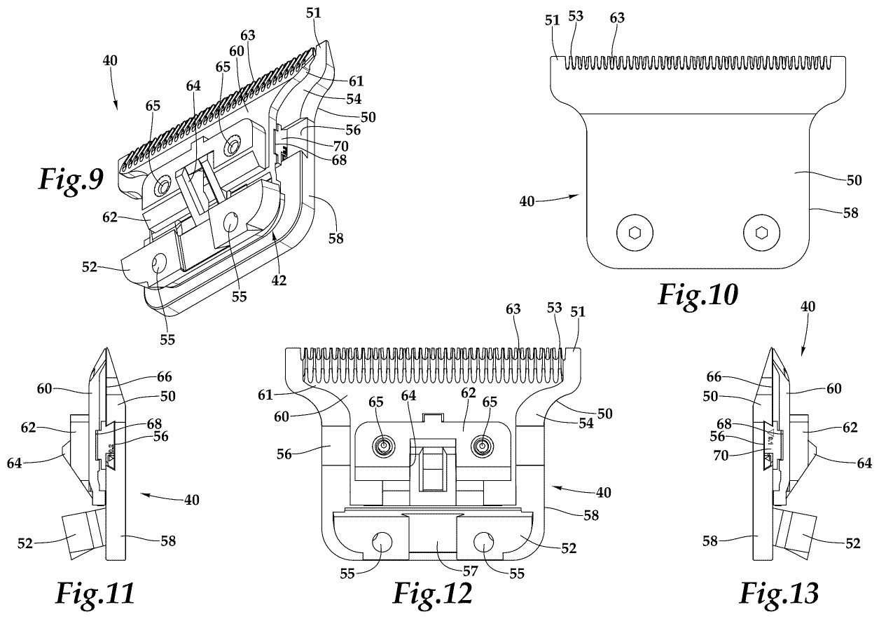

With particular reference to FIGS. 1, 2 and 9-14, details of the head 40 are described, according to this example embodiment. The head 40 provides a cutting implement for the trimmer 10 through interaction of teeth 53, 63 associated with the fixed blade 50 and vibrating blade 60 moving relative to each other (along arrow E of FIGS. 3, 18 and 19). The head 40 includes a gap 42 provided within a base block 52 attached to the fixed blade 50. This gap 42 is provided on each lateral side of the fixed blade 50 of the head 40 and is sized to allow the flanges 27 of the neck 25 to slide therein. In this way, the gap 42 provides for sliding attachment and detachment of the head 40 onto and off of the neck 25 of the handle 20. An outer rim 58 of the fixed blade 50 preferably overlays the neck 25 slightly and defines a perimeter of the head 40, which is visible when the head 40 is attached to the neck 25 of the handle 20.

The fixed blade 50 is thus attached through its base block 52 securely to the neck 25 of the handle 20, when the head 40 is attached to the handle 20, and without any motion between the fixed blade 50 and the handle 20. In contrast, the vibrating blade 60 moves relative to the fixed blade 50 and relative to the handle 20. The fixed blade is a rigid structure, typically formed of a tool steel which can hold a sharp edge, such as along lateral sides of teeth 53 extending to a tip 51 of the fixed blade 50. The tip 51 is defined by a tip line to which each of the teeth 53 of the fixed blade 50 extend. This tip line 51 defines a portion of the head 40 which extends furthest away from the base block 52 of the fixed blade 50.

While this tip 51 always extends to this tip line, the vibrating blade 60 also has a tip line defined by tips 61 of teeth 63 on the vibrating blade 60, which are close to the tip line defined by the tips 51 of the teeth 53 on the fixed blade 50. An offset between the tip 51 of the blade 50 and the tip 61 of the vibrating blade 60 defines whether the trimmer 10 is in its standard configuration (FIG. 19) or its tight configuration (FIG. 18). In one embodiment, the standard configuration involves an offset of 0.2 mm, and the tight configuration involves an offset of 0.1 mm. However, in other embodiments other measurements for any such two configurations could be provided by keeping the tips 51 of the fixed blade 50 extending furthest within the head 40. Potential for the teeth 53, 63 to interact in a way cutting skin of a user is thus substantially precluded, even in the tight configuration. However, the standard configuration provides a greater margin of safety and is often more appropriate for less skilled users and for sensitive skin. When it is desirable to cut the hair as short as possible, the tight configuration is most effective.

Various tools can be utilized to sharpen the teeth 53, 63 and to otherwise modify the teeth 53, 63 to adjust a tightness provided by the trimmer 10 in the two configurations. One such sharpening and modifying tool is described in U.S. Pat. No. 10,556,324, incorporated herein by a reference in its entirety. With some trimmers 10, a spacing between tips 51, 61 of the fixed blade 50 and vibrating blade 60 can to some extent be modified, such as by utilizing a modifier tool, such as that disclosed in U.S. Pat. No. D785,249, incorporated herein by reference in its entirety.

The fixed blade 50 also includes a trapezoidal slot 57 within the base block 52 which can correspond with and be attached to a trapezoid post 29 in the shelf 26 of the handle 20, which further allows for tight fitting and attachment of the fixed blade 50 of the head 40 to the handle 20 without vibration or other movement between the head 40 and handle 20. By making the trapezoidal slot 57 and trapezoid post 29 with tapering side walls, they maintain a tight hold to each other when the head 40 is attached to the handle 20.

The fixed blade 50 includes an undersurface 54 upon which the base block 52 is attached, typically through screws. As an option, the base block 52 could be formed with the fixed blade, 50 or attached in some manner other than threaded fasteners, such as an adhesive, rivets or other mechanical fasteners. The undersurface 54 features a dovetail slot 56, which extends along an entire lateral width of the fixed blade 50 in this embodiment. A center line of the dovetail slot 56 is parallel with the tip line defined by the tips 51 of the teeth 50 of the fixed blade 50.

This dovetail slot 56 has tapering side walls, giving it a dovetail appearance, in this example embodiment. In other embodiments, at least one of the two sides of the slot 56 taper, but not necessarily both of them. In another embodiment, rather than angled or beveled side surfaces for the dovetail slot 56, these side edges could be stepped and still allow for structures associated with the vibrating blade 60 to slide laterally, without being able to be displaced in any manner relative to the dovetail slot 56 other than in this lateral direction (along arrows E and F (FIGS. 3, and 17-19)).

Vibrating blade 60 is slightly smaller than the fixed blade 50 and similarly formed of a rigid material, typically of metal (e.g. tool steel), which can have its teeth 63 sharpened and maintain a sharp character, able to act with the teeth 53 of the fixed blade 50 for cutting hair therebetween. The teeth 63 extend to tips 61 which define a tip line which is parallel with the tip line associated with the tips 50 of the fixed blade 50. However, the tips 61 of the vibrating blade 60 are held back slightly to extend not quite as far as the tips 51 of the fixed blade 50.

A base block 62 attaches to the vibrating blade 60 on a side opposite the fixed blade 50. This base block 62 could be formed with the vibrating blade 60, but typically is attached to the vibrating blade 60 through threaded fasteners or pressfit studs or rivets. In one embodiment, these pressfit studs each have a threaded bore 65 within an interior thereof which receives the screws 80 which hold the dovetail block 70 to the vibrating blade 60.

The base block 62 of the vibrating blade 60 supports a collar 64 at a center thereof which is located adjacent to the eccentric output tip 32 of the motor 30 when the head 40 is attached to the neck 25 of the handle 20. The eccentric output tip 32 resides inside of the collar 64 (or other guide rails) and impacts the collar 64 as the eccentric output tip rotates (along arrow B of FIG. 1). Because the vibrating blade 60 is restrained from any motion relative to the fixed blade 50 and the handle 20 other than lateral back-and-forth motion (along arrow E of FIGS. 3, 18 and 19), the interaction between the eccentric output tip 32 and the collar 64 results in only vibrating back-and-forth motion of the vibrating blade 60 relative to this fixed blade 50.

An inside surface 66 of the vibrating blade 60 between the base block 62 of the vibrating blade 60 and the tips 61 of the teeth 63 is provided with a rectangular recess 68. While this recess 68 has a rectangular cross-section in the embodiment shown, other cross-sections could conceivably be alternatively provided, including a square cross-section, or a trapezoid cross-section, or a stepped cross-section. With such a rectangular cross-section, at least one raised region 76 of the dovetail block 70 can most readily be inserted into this rectangular recess 68 for attachment of the dovetail block 70 in removable fashion to the vibrating blade 60.

The recess 68 is oversized relative to the at least one raised region 76, to allow the block 70 to be asymmetrical and still fit in the recess 68 in either of two orientations (FIGS. 18 and 19). The through bore 78 is slightly off center relative to the dovetails 74, so that this asymmetry is provided, and the recess 68 accommodates both orientations, with a small gap either at the top offset 77 or at the bottom offset 77 or at the bottom offset 79, but so slight (e.g. 0.1 mm) that it does not show in the drawings. The rectangular recess 68 preferably extends along an entire lateral width of the vibrating blade 60, but could conceivably stop short of extending entirely between lateral edges of the vibrating blade 60.

The dovetail block 70 is provided which is removably attachable to the vibrating blade 60, and which resides partially within the dovetail slot 56 of the fixed blade 50 for attachment to the fixed blade 50, but in a manner which allows sliding of the dovetail block 70 and attached vibrating blade 60 relative to the fixed blade 50 (along arrow E of FIGS. 3, 18 and 19). This dovetail block 70 is preferably a rigid mass of material which includes a first side 71 opposite of second side 72. One of these sides has the at least one raised region 76 (and typically two such raised regions 76), which are sized and shaped to fit within the at least one recess 68 in the inside surface 66 of the vibrating blade 60.

The threaded bores 65 in the vibrating blade 60 and base block 62 are aligned with through bores 78 in the dovetail block 70, which also pass through these rectangular raised regions 76, to receive screws 80 therethrough and for attachment of the dovetail block 70 to the vibrating blade 60 within the rectangular recesses 68 thereof. While the dovetail block 70 is referred to this way because it includes a dovetail 74 on a side thereof opposite the rectangular raised regions 76, the dovetail 74 could be replaced with some other structure which would have a complementary fit within the dovetail slot 56 of the fixed blade 50. For instance, if the dovetail slot 56 were instead configured with a stepped form, the dovetail 74 of the dovetail block 70 could also be provided with a corresponding step form. At a minimum, preferably the slot 56 has a cross-section (perpendicular to the tip line of the teeth 53) with a similar size at an outer part of the slot than at a floor of the slot. The dovetail 74 of the dovetail slot 70 can slide within the dovetail slot 76 in a lateral fashion parallel with the tip lines of the tips 51, 61, to facilitate vibrating of the vibrating blade 60 relative to the fixed blade 50, but while keeping the vibrating blade 60 tight against the fixed blade 50.

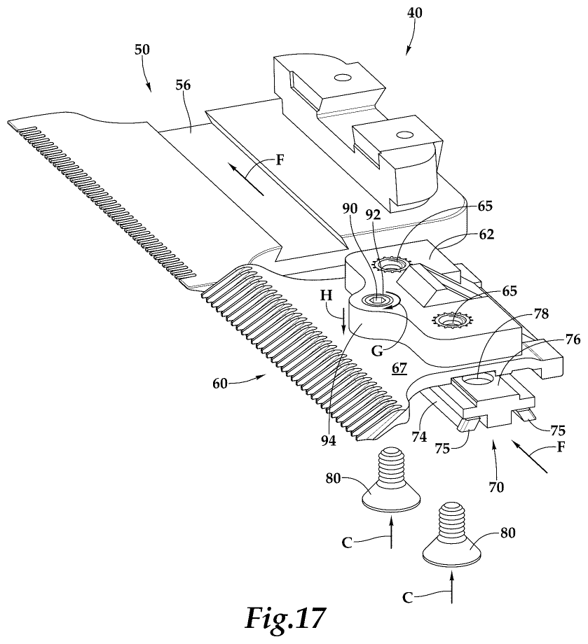

To facilitate ease in sliding the dovetails 74 into the dovetail slot 56, dovetail tips 75 (FIG. 17) can be formed of a more flexible material than other parts of the dovetails 74 and/or the dovetail tips 75 can have their edges beveled. At least one of the dovetail tips 75 at each end of the dovetail block 70 would be configured as an option to facilitate a user sliding the dovetail block 70 into the dovetail slot 54.

Importantly, the raised regions 76 of the dovetail block 70 have a top offset 77 and a bottom offset 79 on lateral sides thereof which are slightly different in size. The top offset 77 is slightly lesser in size than the bottom offset 79. In this way, when the top offset 77 is on a side of the rectangular slot 76 of the vibrating blade 60 closest to the tip 61 of the vibrating blade 60, the vibrating blade 60 is caused to be in its tight configuration relative to the fixed blade 50, when the dovetail block 70 is attached to the vibrating blade 60 in this manner and has its dovetail 74 fitted within the dovetail slot 56 of the fixed blade 50 (FIG. 18). However, when the dovetail block 70 is removed from the vibrating blade 60, reoriented in an opposite orientation and reattached to the rectangular slot 68 of the vibrating blade 60, so that the bottom offset 79 is closer to the tips 61 of the teeth 60 through the vibrating blade 60, the vibrating blade is caused to have its teeth 63 slightly further from the tips 51 of the teeth 53 of the fixed blade 60, putting the head 40 of the trimmer 10 in its standard configuration (FIG. 19).

It can be seen that different offsets 77, 79 of different sizes could be provided so that differing distances are provided between the tight configuration and the standard configuration in alternative embodiments. As a further option, additional dovetail blocks could be provided in a kit along with the dovetail block 70, which could have different offsets, so that different offsets between the tips 51 of the teeth 53 of the fixed blade and the tips 61 of the teeth 63 of the vibrating blade 60 could be provided when such alternative dovetail blocks are used to replace the dovetail block 70. For instance, a dovetail block could be provided which provides an offset of 0.3 mm or 0.4 mm, depending on the orientation that it has when attached to the vibrating blade 60. Preferably the vibrating blade 60 and/or dovetail block 70 are provided with indicia thereon which are visible and which indicate to a user whether the dovetail block 70 is oriented to provide a tight configuration or a standard configuration.

The screws 80 (FIG. 17) can be tightened extra (or not) to enhance (or not) friction between the fixed blade 50 and the vibrating blade 60. Furthermore, as an option, a set screw 90 (FIG. 17) can be provided within a threaded hole 92 in a protrusion 94 extending from the base block 62 of the vibrating blade 60. The set screw 90 can be tightened (or loosened) along arrow G to interact with the threaded hole 92 and be pushed into an outside surface 67 of the vibrating blade 60 (along arrow H of FIG. 17). In this way, tension and/or friction between the blades 50, 60 can be further tuned by a user. In one embodiment, this set screw 90 has a faceted hole that is accessible by a torque applying tool even when the head 40 is attached to the handle 20, by this set screw 90 being located just outside of the neck 25 of the handle 20.

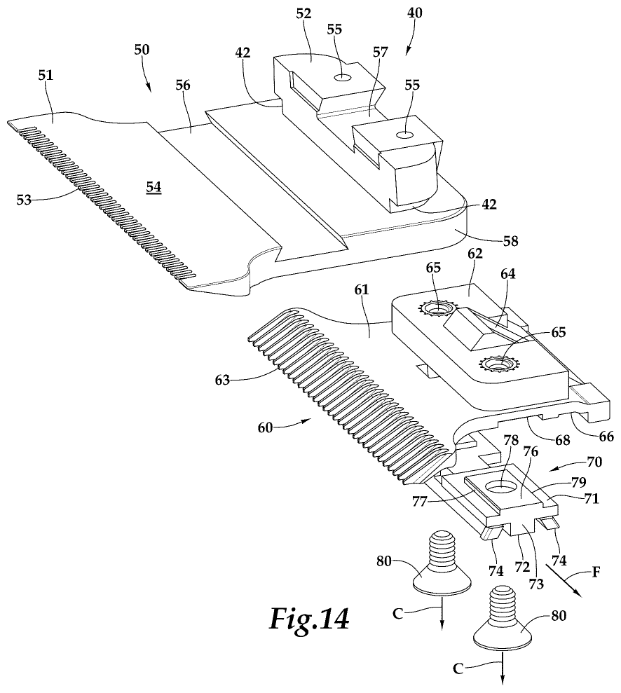

In use and operation, and with particular reference to FIGS. 14-17, a series of steps in the process of re-orienting the dovetail block 70 are shown, according to one example embodiment. Initially, the head 40 is assembled together with the vibrating blade 60 adjacent to the fixed blade 50 and with the dovetail block 70 joining the vibrating blade 60 to the fixed blade 50. When the head 40 is removed from the handle 20 of the tool 10 (FIG. 2) the vibrating blade 60 and attached dovetail block 70 can be slid laterally entirely off of the fixed blade 50 (along arrow F of FIG. 14). Once the vibrating blade 60 and associated dovetail block 70 have been removed from the fixed blade 50, the screws 80 can have heads thereof accessed, and they can be removed from the dovetail block 70 and vibrating blade 60 (along arrow C of FIG. 14).

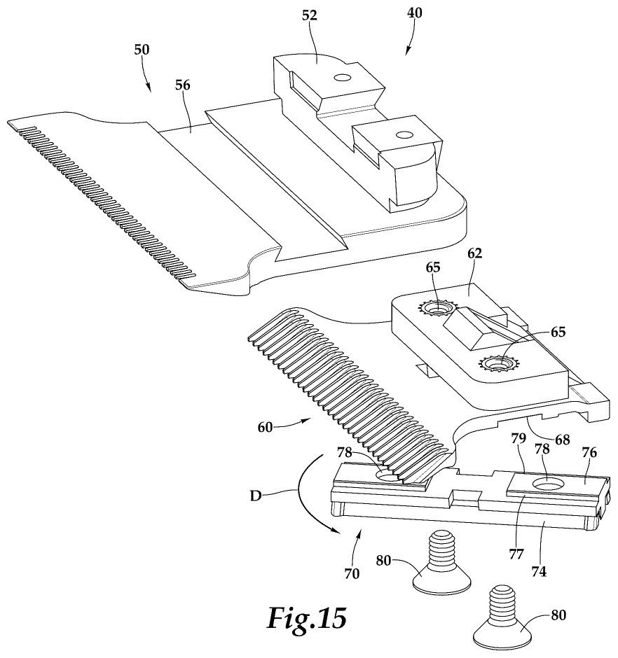

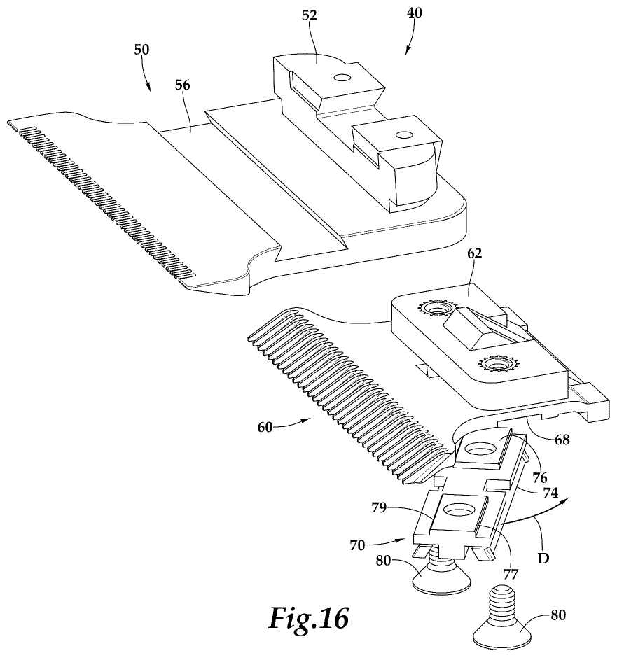

The dovetail block 70 can then be rotated/flipped (along arrow D of FIGS. 15 and 16) to swap ends of the dovetail block 70 and cause it to be reoriented 180° from its original configuration to a final configuration (FIG. 17). Dovetail block 70, after such reorientation and flipping, can then have the screws 80 reattached (along arrow C of FIG. 17) to reattach the dovetail block 70 to the vibrating blade 60. The vibrating blade 60 and dovetail block 70 can then together be slid back into the dovetail slot 56 of the fixed blade 50 (along arrow F of FIG. 17) to reattach the vibrating blade 60 to the fixed blade 50, in a manner precluding motion therebetween, other than lateral vibrating motion (along arrow E of FIGS. 3, 18 and 19). Depending on which orientation the dovetail block 70 has within the rectangular recess 68 of the vibrating blade 60, the tips 61 of the teeth 63 are either positioned in a tight configuration (FIG. 18) with a 0.1 mm offset (for instance) or with a standard offset (FIG. 19), with a 0.2 mm (for instance) offset between the teeth 63 of the vibrating blade 60 and the teeth 53 of the fixed blade 50. The head 40 can then be reattached to the handle 20 (along arrow A of FIG. 2) and the tool 10 is ready for use in the new configuration.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: A trimmer for cutting hair, the trimmer comprising in combination:
a handle;
a head assembly attached to the handle;
said head assembly including a fixed blade and a vibrating blade;
said fixed blade having a plurality of teeth extending to a common fixed blade tip line;
said vibrating blade having a plurality of teeth extending to a common vibrating blade tip line;
a vibrating output causing said vibrating blade to vibrate relative to said fixed blade in an at least partially lateral direction relative to said fixed blade tip line;
said vibrating blade having at least two positions, including a regular position and a tight position, said tight position locating said vibrating blade tip line closer to said, fixed blade tip line then said regular position; and
said vibrating blade movable between said regular position and said tight position.

2: The trimmer of claim 1 wherein said handle includes a neck, said head assembly removably attachable to said neck of said handle.

3: The trimmer of claim 2 wherein said vibrating output is supported by said handle and extends out of said neck for engagement with at least a portion of said head assembly.

4: The trimmer of claim 1 wherein said fixed blade includes a slot on a side of said fixed blade facing said vibrating blade and extending parallel with said fixed blade tip line.

5: The trimmer of claim 4 wherein said slot extends an entire width of said fixed blade.

6: The trimmer of claim 4 wherein said slot has a cross-section with a smaller size at an outer part of said slot than at a floor of said slot.

7: The trimmer of claim 6 wherein said vibrating blade includes a dovetail block residing partially within a recess in said vibrating blade through at least one raised region of said block sized to have a width perpendicular to said tip line of said vibrating blade which is less than a width of said recess perpendicular to said tip line, and wherein said block is also held partially within said slot of said fixed blade in a manner allowing vibrating motion parallel with said tip lines between said vibrating blade and said fixed blade.

8: The trimmer of claim 7 wherein said block can have said raised region fit within said recess of said vibrating blade in two orientations rotated 180° from each other, including a standard orientation and a tight orientation, and with said raised region closer to said tip line of said vibrating blade when in said tight orientation than when in said standard orientation.

9: The trimmer of claim 8 wherein said block includes a dovetail on a side of said block opposite said at least one raised region, and wherein said fixed blade includes said slot having dovetail corners therein, said slot sized to receive said dovetail of said block therein, said slot and said dovetail having constant cross-sectional forms to allow movement of said block within said slot of said fixed blade along a vibrating path parallel with said tip line of said fixed blade.

10: The trimmer of claim 9 wherein said block is attached to said vibrating blade through at least one removable fastener.

11: The trimmer of claim 10 wherein said block is attached to said vibrating blade through a pair of screws, passing along through bores in said block and extending into threaded bores in said vibrating blade, and wherein said through bores are located asymmetrically relative to said dovetail.

12: A hair trimmer, comprising in combination:
a handle;
a head removably attachable to said handle;
said head including a fixed blade and a vibrating blade with said fixed blade fixed to said handle when said head is attached to said handle and said vibrating blade vibrating relative to said fixed blade;
said fixed blade and said vibrating blade each having a plurality of teeth extending to blade tip lines for each of said blades, said blade tip lines each parallel with a direction of vibration of said vibrating blade relative to said fixed blade;
said blade tip lines offset from each other with said blade tip line of said vibrating blade stopping short of said blade tip line of said fixed blade by an offset distance;
a block between said fixed blade and said vibrating blade, said block holding said fixed blade to said vibrating blade in a manner allowing only lateral vibrating linear motion between said fixed blade and said vibrating blade; and
said block movable between a standard orientation and a tight orientation, with said tight orientation causing said offset distance to be smaller than when said block is in said standard orientation.

13: The hair trimmer of claim 12 wherein said standard orientation and said tight orientation for said block are selectable by rotating said block between said standard orientation and said tight orientation.

14: The hair trimmer of claim 13 wherein said block is rotatable 180° to move between said standard orientation and said tight orientation.

15: The hair trimmer of claim 13 wherein said block includes a dovetail on a side thereof, said dovetail having a constant cross-sectional form, and wherein said fixed blade includes a dovetail slot therein sized similar to said dovetail of said block, said dovetail slot having a constant cross-sectional form extending parallel with said tip line of said fixed blade and with said block removable attachable to said vibrating blade.

16: The hair trimmer of claim 15 wherein said block includes at least one raised region on a side of said block opposite said dovetail, said raised region sized to fit within a recess in said vibrating blade, and wherein at least one fastener holds said block to said vibrating blade in a removable fashion.

17: The hair trimmer of claim 16 wherein said at least one raised region has a rectangular cross-section, and wherein said recess in said vibrating blade has a rectangular cross-section, with said at least one raised region fitting within said recess of said vibrating blade.

18: The hair trimmer of claim 16 wherein said block has at least one through bore for at least one fastener which through bore asymmetrically located relative to said dovetail, and with said block placing said vibrating blade within said tight orientation when said block is oriented with said through bore further from said tip line of said vibrating blade than when said block is oriented placing said vibrating blade within said standard orientation with said through bore closer to said tip line.

19: The hair trimmer of claim 16 wherein said fastener includes at least one screw passing along said at least one through bore passing through said block and threaded into a threaded bore in said vibrating blade.

20: A method for switching a hair trimmer between a standard orientation and a tight orientation, with the standard orientation cutting hair less short than said tight orientation, the method including the steps of:
removing a head of the trimmer from a handle of the trimmer;
disassembling the head of the trimmer into a separate fixed blade and a separate vibrating blade by sliding a block removably attachable to the vibrating blade laterally out of a slot in the fixed blade, extending parallel with a tip line of the fixed blade to which teeth of the fixed blade extend;
detaching the block from the vibrating blade;
rotating the block 180°;
reattaching the block to the vibrating blade;
reassembling the head of the trimmer by sliding the block back into the slot of the fixed blade, with the tip line of the fixed blade and the tip line of the vibrating blade now closer to each other than they were previously; and
reconnecting the head to the handle.
